(19) United States
(12) Patent Application Publication
(10) Pub. No.: US 2007/0144970 A1
(43) Pub. Date: Jun. 28, 2007

(54) Supported zeolite membranes, their process for production and their applications

(76) Inventors: Cecile Barrere Tricca, Soucieu-en-Jarrest (FR); Anna Omegna, Rosenheim (DE); Loic Rouleau, Charly (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/641,963

(22) Filed: Dec. 20, 2006

(30) Foreign Application Priority Data
Dec. 21, 2005 (FR) 05/13.067

(51) Int. Cl. B01D 61/00; C01B 39/00; B01J 29/04; B01J 20/28

(52) U.S. Cl. 210/650; 502/60; 423/700; 423/705; 502/4

(57) ABSTRACT

This invention relates to a process for the preparation of a supported zeolite membrane that consists of a zeolite/substrate composite layer, whereby the crystallization stage is carried out while being stirred by a hydrothermal treatment of the immersed substrate. In addition, the process satisfies at least one of the following requirements: The crystallization is carried out with a water/silica molar ratio of 66-100, Before the crystallization stage, the porous substrate is pretreated by covering it at the outer periphery, where the zeolite is not desired, with a polytetrafluoroethylene film and by impregnating it with water in the pores where the zeolite is not desired, and the crystallization is conducted with a water/silica molar ratio of 10-100.

The invention relates to supported zeolite membranes that have a very high ideal N₂/SF₆ permselectivity or selectivity as well as a very high N₂ flow. It also relates to the processes for preparation of these supported membranes as well as to their applications by separation by one or more of the following methods: size difference of molecules to be separated (steric exclusion), difference in the rate of diffusion of the molecules to be separated (kinetic separation), and difference of chemical affinity of the molecules to be separated with the membrane (thermodynamic separation).

A zeolite is an oxide that has a three-dimensional structure that results from the linking of tetrahedral units leading to a network of channels of molecular dimension, with pore diameters varying from 3 to 10 Å (Ch. Baerlocher, W. M. Meier, D. H. Olson, Atlas of Zeolites Structure Types, 5^{th} Edition, Elsevier, 2001). A zeolite is typically a silico-aluminate and is now extended to other compositions leading to a uniform three-dimensional structure, in particular a metallosilicate, such as, for example, alumino-silicate, boro-silicate, ferro-silicate, titano-silicate, alumino-phosphate, gallo-phosphate, and silico-alumino-phosphate.

The zeolite can be of MFI structural type (Ch. Baerlocher, W. M. Meier and D. H. Olson, Atlas of Zeolites Structure Types, 5^{th} Edition, 2001). It can come under different compositions. For example, the ZSM-5 zeolite is an alumino-silicate (U.S. Pat. No. 3,702,886) and the silicate-1 is purely silicic (U.S. Pat. No. 4,061,724). This structure has two interconnected channel systems formed by cycles with 10 interconnected tetrahedrons, one that is sinusoidal and the other that is rectilinear.

The zeolites are generally synthesized by carrying, under hydrothermal conditions, at a temperature that is set between 50 and 250° C., for a duration varying from several hours to several days, under autogenous pressure, an aqueous precursor mixture that contains the sources of the framework elements, a mineralizing source that makes it possible to put framework elements into solution and a structuring source that helps organize them into zeolites.

“Framework element” is defined as an element that will form the structural skeleton of the zeolite. The framework elements are in particular silicon, aluminum, boron, iron, titanium, phosphorus and gallium.

The MFI structural type zeolite is synthesized under very variable composition and crystallization conditions.

Various processes for developing zeolite membranes have already been described.

The International Patent Application WO-A-95/2975i describes an operating procedure for obtaining composite membranes that are supported by an inorganic macroporous matrix. In the International Patent Application WO-A-00/33948, a process for obtaining composite membranes of zeolite supported on optionally multi-channel tubular solids is described. All of these composite membrane materials based on zeolite are formed by a zeolite phase that is deposited on a substrate. A series of patents (U.S. Pat. No. 5,871,650, U.S. Pat. No. 5,968,366, U.S. Pat. No. 6,090,289, U.S. Pat. No. 6,074,457, WO-A-00/53297, and WO-A-00/53298) describes the preparation of zeolite membranes whose MFI-structural-type zeolite phase is found on the outside surface of a porous substrate. A drawback of the membranes according to the prior art is that they generally exhibit an inadequate crystallinity, and/or the presence of (an) amorphous zone(s) entrains unsatisfactory performance levels of molecular separation and in particular an unsatisfactory selectivity. Some authors recommend crystallization in several stages to obtain a continuous layer. However, such a process forms thick layers of zeolites, which run the risk of cracking either during the calcination of the membrane (Vroon, Z. A. E. P., Keizer, K., Burggraaf, A. J., Verweij, H., J. Membr. Sci. 144 (1998) 65-76) or else during the use of the membranes. Furthermore, the increase in thickness can considerably limit the transfer of material through the membrane and can lead to a reduction of separation productivity.

One of the difficulties linked to the preparation of zeolite-based membranes resides in particular in the monitoring of the crystallization of the zeolite so as to obtain zeolite crystals that are duly linked to the substrate, located primarily in the pores of the substrate and forming a continuous zeolite/substrate composite layer that is without any intercrystalline pores and is thin enough to limit the transfer resistance through the membrane material. Attempts to improve the conventional processes have been described in particular in EP 1 230 972, which describes a non-isothermic crystallization, EP 1 369 166, which describes the implementation of the crystallization stage with a relatively dilute precursor solution (molar ratio of H₂OSiO₂=45-65), and EP 1 369 167, which describes a process for preparation of a supported zeolite membrane with a crystallinity of more than 85% with preparation of a relatively concentrated gel (molar ratio of H₂O/SiO₂=25-35).

These processes are not, however, completely satisfactory in terms of the separation result. In addition, they are not totally reproducible and can lead to non-fluidtight membranes before calcination that cannot be used and increase the overall cost of production.

In a controlled and reproducible manner, with a limited failure rate (sealing defect), and with a simple process, it appears difficult to date to obtain zeolite membranes that exhibit a satisfactory compromise between thinness of the layer and continuity of this layer, i.e., a thinness such that the flow rates in use can be high while being essentially free of intercrystalline gaps.

These inventors, after in-depth research, have found that supported membranes that have an ideal N₂/SF₆ permselectivity of more than 45, preferably more than 60, and more preferably more than 80, would make it possible to obtain such a compromise.

The ideal permselectivity or selectivity is the ratio of nitrogen permeance/SF₆ permeance, whereby the permeances are measured under the following operating conditions: the supported zeolite membrane is plugged at one end, and a pressure of 2.5 bar absolute of pure gas (N₂ or SF₆) is imposed in the interior, the flow of pure gas through the membrane is measured, whereby the test is carried out at ambient temperature.

This type of test is described and used in Ind. Eng. Chem. Res. 1998, 37, 166-176.

Recall that the permeance of a gas, expressed in terms of mol/m²·s·Pa, is, by definition, the molar flow rate of this gas related to the unit of membrane surface area and related to the partial-pressure difference of this gas between the upstream (where the feedstock circulates) and the downstream (where the permeate is recovered). The permeance of a gas is therefore the molar flow rate of this gas that passes through the membrane per unit of surface area and pressure.

To conduct this measurement of permeance, the supported membrane is plugged at one end, and a pressure of 2.5 bar absolute of pure gas (SF₆ or N₂) is imposed in the interior of the membrane, the exterior being at atmospheric pressure,

The zeolite membrane consists of a thin layer of zeolite crystals located for the most part in the pores of the substrate. In a preferred manner, the (volume of zeolite detected inside the pores of the peripheral layer of the substrate)/(volume of zeolite detected inside the pores of the peripheral layer of the substrate+volume of zeolite detected outside of the pores of the peripheral layer) is 60%, and even 70%, and even 80%. The membrane is characterized by permeability properties of the zeolite layer, the membrane limits the permeability of molecules that cannot diffuse into the pores of the zeolite because of the very small presence of defects, in particular sulfur hexafluoride (SF₆), and it offers a high permeability for molecules with high diffusion in the pores of the zeolite, in particular nitrogen, because of a slight thickness of the layer. The locating of the zeolite in the pores of the substrate associated with the nature of the substrate imparts an excellent thermal and mechanical stability to the membrane.

According to an embodiment of the invention, the zeolite phase is of the MFI structural type.

According to the invention, the porous substrate is suited to the conditions of the processes for separation, in particular for refining, petrochemistry and gas treatment. It is made of, for example, inorganic material, for example ceramic, alumina, zirconia, silica, titanium oxide, carbon, metal, metal alloy, in particular stainless steel, or aluminum. It can also be made of polymer or consist of a mixture of these different materials.

According to a particular embodiment of the invention, the substrate material can even be a source of the structural elements of the zeolite.

The substrate material should have a suitable porosity in the desired zone for formation of the zeolite layer so as to allow the crystallization of the latter. This porosity can be located in the range from 4 nm to 100 μm, preferably from 4 nm to 10 μm, and more preferably from 0.1 to 1 μm.

The substrate material may have a homogeneous structure, i.e., at any point of the substrate, the material is identical with regard to its composition, its crystallography and its porosity, or else it can exhibit a heterogeneous structure, i.e., the material is not identical at all points of the system but exhibits different juxtaposed zones of identical material. All of the geometries can be suitable for the substrate and the latter can be, for example, tubular, spiral, flat, in the shape of a disk, sheets or else fibers, in particular hollow fibers whose surface/volume (compactness) ratio is high.

According to a first preferred embodiment, the supported zeolite membrane has an ideal N₂/SF₆ permselectivity of at least 48, preferably at least 62, and more preferably at least 81, and an N₂ permeance of at least 22·10⁻⁷ mol/s·m²·Pa, preferably at least 26·10⁻⁷ mol/s·m²·Pa, and more preferably at least 30·10⁻⁷ mol/s·m²·Pa.

According to a second preferred embodiment, the supported zeolite membrane has an ideal N₂/SF₆ permselectivity of at least 60, preferably at least 76, and more preferably at least 93, and an N₂ permeance of at least 34·10⁻⁷ mol/s·m²·Pa, preferably at least 39·10⁻⁷ mol/s·m²·Pa, and more preferably at least 43·10⁻⁷ mol/s·m²·Pa.

As is done conventionally, the zeolite membranes are prepared by various methods, in particular by direct synthesis of zeolite on the substrate or indirect synthesis with preliminary deposit of zeolite nuclei on the substrate, then growth of the latter. The methods for preparation generally comprise the preparation of the precursor mixture that is necessary to the formation of the zeolite, the bringing of the nuclei and the precursor mixture into contact with the substrate, the synthesis of the zeolite under hydrothermal conditions, the removal of the pores from the zeolite by calcination, then optionally modifications of the zeolite by ion exchange. Preferably, a direct synthesis of the zeolite on the substrate will preferably be carried out so as to help locate the thin layer of zeolite crystals in the pores of the substrate.

More particularly, the membranes of the invention can be prepared with a process comprising:

a) The formation of a gel or a solution that comprises at least one source of silicon and water, with at least one structuring organic compound added, a mineralizing agent such as a hydroxide source, and optionally another framework element that is selected from the group that comprises aluminum, boron, iron, titanium, phosphorus and gallium;

b) Bringing said gel or said solution that is obtained in stage a) into contact with the substrate;

c) The crystallization of the zeolite from said gel or said solution, and

d) The elimination of the residual agents by calcination,

whereby the crystallization stage c) is conducted while being stirred, said process also satisfying at least one of the following requirements:

The crystallization is conducted with a water/silicon molar ratio of 10-100, preferably 40-90, and more preferably 60-80,
Before the crystallization stage, the porous substrate is pretreated so as to make certain porous zones or certain outside surfaces unavailable to the formation of zeolite crystals.

At the end of stage a), the molar composition of the solution or of the gel is as follows:

1 SiO₂-x (organic compound)-y H₂O,

x and y respectively representing the organic compound/silica molar ratio and the water/silica molar ratio.

According to the invention, the crystallization of the zeolite is carried out in a single stage, i.e., the zeolite is crystallized by a single hydrothermal treatment requiring stirring. The stirring of stage c) is conducted by putting into motion either said gel or the porous substrate or both.

The crystallization stage (c) is carried out at a temperature of between 50 and 250° C., preferably between 100 and 220° C., and more preferably between 150 and 200° C.

The duration of the crystallization stage is the one necessary for the formation of the zeolitic layer.

Advantageously, the duration of crystallization of the zeolite in stage (c) is at least 40 hours, and even more advantageously it is at least 55 hours.

The silicon source used in stage (a) of the process according to the invention does not contain any impurity that could affect the synthesis of the zeolite. It can be in particular pyrogenic silica, colloidal silica, precipitated silica, silicon alkoxides or mixtures thereof.

It is at times advantageous to use the porous substrate as a silicon source, optionally with an outside supply.

Other elements can also be introduced in a minority amount during stage (a) of the process according to the invention: in particular, aluminum, boron, gallium, iron, titanium and phosphorus as well as the mixture thereof.

The structuring organic compound or precursors thereof, used in stage (a), is selected from the group that comprises quaternary ammoniums, such as tetrapropyl ammonium (TPA) (U.S. Pat. No. 3,702,886), triethylpropyl ammonium (TEPA)° (S. B. Kulkarni et al., Zeolites 2 (1982), 313), tripropylmethyl ammonium (TPMA) (EP28516), tributylmethyl ammonium, tributylethyl ammonium, tributylhexyl ammonium, tributyloctyl ammonium, trimethylbenzyl ammonium, diethylpropylethyl ammonium, N,N,N,N′,N′,N′-hexamethyl-1,6-hexanediammonium (E. Moretti et al., Chem Ind, 67 (1985) 21); the amines such as propylamine, isopropylamine (U.S. Pat. No. 4,151,189), 3-dimethylamino-2,2′-dimethyl-1-propanol (U.S. Pat. No. 4,376,104), 1,5-diaminopentane, 1,6-diaminohexane, 1,12-diaminododecane (U.S. Pat. No. 4,108,881), diethanol amine (BE895663), dimethanolamine, trimethanolamine, ethanolamine, monoisopropanolamine, monopropanolamine (U.S. Pat. No. 4,346,021), 3-dimethylamino-2,2-dimethyl-1-propanol (U.S. Pat. No. 4,376, 104), morpholine (U.S. Pat. No. 4,377,502), N-ethylpiperidine (E. Moretti et al., Chem Ind 67 (1985) 21); the alcohols such as ethanol (U.S. Pat. No. 4,341,748), 1,6-hexanediol, pinacol, 1,12-dodecanediol, 2,2-dimethyl-1,3-propanediol (EP42225), glycerol, 1,2-propanediol, triethylene glycol, 1,4-cyclohexanedimethanol; the ethers such as ethylene glycol dimethyl ether, diethylene glycol dimethyl ether, triethylene glycol dimethyl ether, tetraethylene glycol dimethyl ether, tetrahydrofuran, diethyl ether (EPS1741); various organic compounds such as 1-methyl-4-aza-1-azoniabicyclo[2,2,2]octane-4-oxide iodide (U.S. Pat. No. 4,285,922), oxyethyl lactamide (H. Nalcamoto et al., Chem. Lett. (1981) 169), ethylenediiminetetraacetic acid (EDTA), nitrilotriacetic acid, methylanoxide (U.S. Pat. No. 4,285,922), tripropylanoxide (U.S. Pat. No. 4,430,3 19), tripropylamine-N-oxide, hydroquinone (NE8101216), carboxymethyl cellulose, cellulose hydroxy ethyl ether (GB2123993), sodium n-dodecyl benzene sulfonate (H. Hagiwara et al., Chem. Lett (1981) 1653, sodium n-alkyl-polyoxyethylene sulfate (J. Batista et al., Stud. Surf. Sci. Catl. 24 (1985) 97. The references between parentheses are documents that describe the crystallization of a zeolite from the structuring organic compound or its corresponding precursor.

More particularly, the zeolite ZSM-5 and the silicalite-1, of MFI structural type, can be synthesized in particular from a clear solution, i.e., a solution that does not make it possible to visualize the precursors in suspension (J. E. Otterstedt, D. A. Brandreth, Small Particles Technology, Plenum Press, 1998). They can be synthesized in aqueous medium from a source of silicon and aluminum as framework elements, a hydroxide source as well as a mineralizing agent, and a TPA source as a structuring agent.

In stage a), the molar ratio of the structuring organic compound to the silica in said gel or said solution is between 0.2 and 0.8, preferably between 0.2 and 0.6, and more preferably between 0.3 and 0.5.

The stage for eliminating residual agents by calcination makes it possible to remove the pores from the zeolite, in particular from the organic structure. This stage is conducted at a temperature of 400 to 800° C., preferably 425 to 700° C., and more preferably from 450 to 600° C., until all the pores are removed, typically for more than one hour. Generally, a heat treatment in air is ensured with a slow rate of temperature rise so as to avoid, for example, the degradation of the membrane by the exothermy that is produced by the decomposition into organic structuring agent: typically the rate of temperature rise is less than 5° C./minutes. It is also possible to control the dilute oxygen content in a cover gas by using, for example, an air-nitrogen mixture with 5% volume of O2.

Before the stage for eliminating residual agents by calcination, all of the membranes have zero nitrogen permeance.

According to an embodiment that is particularly suited to the preparation of the membranes according to the first preferred embodiment, the crystallization stage is carried out with a very large amount of water. Thus, the water/silica molar ratio is between 66-100, preferably 67-90, and more preferably 70-80.

This process for preparation can then be conducted in the following way:
A relatively dilute precursor solution is prepared: the latter has the following molar composition:
   1 SiO₂-x(organic compound)-y H₂O with
      x=0.2-0.8, preferably x=0.2-0.6, and more preferably x=0.3-0.5;
      y=66-100, preferably y=67-90, and more preferably y=70-80;
This solution is brought into contact with the substrate, for example by complete immersion of said substrate in the precursor solution;
The synthesis of the zeolite by hydrothermal treatment of the immersed substrate is then carried out while being stirred with putting into motion the precursor mixture, the substrate or the substrate-mixture pair, in an autoclave, at a temperature of between 50 and 250° C., preferably between 100 and 220° C., and more preferably from 150 to 200° C., for a duration that is necessary for obtaining the membrane;
The removal from the zeolite is then carried out by calcination in air or nitrogen/oxygen mixing at 400-800° C., preferably 425-700° C., and more preferably 450-600° C.

According to an embodiment that is particularly suited for the preparation of membranes according to the preferred second embodiment, the porous substrate undergoes a pretreatment before the crystallization stage so as to make unavailable certain porous zones or certain surfaces outside of the formation of zeolite crystals. The pretreatment of said porous substrate can be carried out by covering porous zones in which the zeolite is not to be formed with a compound that prevents the diffusion of said gel or said solution and that is resistant to the synthesis conditions of the zeolite. The pretreatment of the porous substrate is carried out by covering the zone or zones of the substrate where it is not desired that the zeolite be formed, with a solid such as a polymer film, a liquid such as weather or a pressurized gas, or by a combination of the latter. The crystallization can then be conducted by using a solution whose water/silica ratio is between 10-100, preferably 40-90, and more preferably 60-80.

This process for preparation can then be conducted in the following way:
A precursor solution is prepared: the latter has the following molar composition:
   1 SiO₂-x (organic compound)-y H₂O with
      x=0.2-0.8, preferably x=0.2-0.6, and more preferably x=0.3-0.5;
      y=10-100, preferably y=40-90, and more preferably y=60-80;
The substrate is pretreated by filling the substrate zone or zones where it is not desired that the zeolite be formed or by covering it at the outer periphery or peripheries of the substrate, where it is not desired that the zeolite be formed, for example the substrate can be impregnated with water in the pores where the zeolite is not desired and covered by a polytetrafluoroethylene (Teflon®) film at the outer periphery, where the zeolite is not desired, whereby these two agents act as a diffusion barrier;
The precursor solution is brought into contact with the substrate that is pretreated by, for example, complete immersion of said pretreated substrate in the precursor solution;
The synthesis of the zeolite by hydrothermal treatment of the immersed pretreated substrate is then carried out, while being stirred, with the putting into motion of the precursor mixture, the substrate or the substrate/mixture pair, in an autoclave, at a temperature of between 50 and 250° C., preferably between 100 and 220° C., and more preferably from 150 to 200° C., for a duration that is necessary for obtaining the membrane;
The removal from the zeolite is then conducted by calcination in air or nitrogen/oxygen mixing at 400-800° C., preferably at 425-700° C., and more preferably 450-600° C.

According to a particularly preferred embodiment, the process according to the invention comprises a stage for pretreatment of the porous substrate and a stage for crystallization carried out with a water/silica molar ratio of 10-100, preferably 40-90, and more preferably 60-80.

The zeolite membranes according to the invention can be used for the separation of gas, vapors or liquids. The separation is based on a kinetic discrimination (diffusion) and/or steric and/or thermodynamic exclusion (chemical affinity).

They are particularly suited to the different separation processes below:
Separation of linear hydrocarbons (saturated and/or unsaturated) and branched hydrocarbons (saturated and/or unsaturated) that comprise 4 to 8 carbon atoms, more particularly the separation of linear and branched isomers, the separation of linear paraffins and branched paraffins, and the separation of linear olefins and branched olefins;
Separation of aromatic compounds and naphthenes;
Separation of paraffins and olefins;
Separation of linear hydrocarbons and naphthenes, more particularly the separation of paraffins and naphthenes;
Separation of linear hydrocarbons and aromatic hydrocarbons, more particularly the separation of paraffins and aromatic hydrocarbons;
Separation of branched hydrocarbons relative to one another according to their degree of branching, more particularly the separation of mono-branched and di-branched and/or multi-branched hydrocarbons;
Separation of isomers of xylene;
Separation of the following gaseous mixtures: methane/nitrogen, methane/carbon dioxide, methane/carbon monoxide, carbon dioxide/carbon monoxide, and nitrogen/oxygen;
Separation of methane and sulfur-containing compounds, more particularly the separation of methane/hydrogen sulfide or methane/COS;
Separation of hydrogen/hydrocarbons, nitrogen/hydrocarbons, hydrogen/carbon dioxide, and hydrogen/carbon monoxide;
Separation of oxidized organic molecules and water, for example separation of alcohols and water;
Separation of alcohol and ethers.

The membranes according to the invention make it possible to obtain very satisfactory separation performance levels. Such performance levels are evaluated with the measurement of the permeance of the nC4/i-C4 mixture under the following conditions:
Temperature: 175° C.,
Internal pressure: 1.3 bar absolute,
External pressure: 1 bar absolute,
Counter-current helium scavenging outside of the membrane at 10⁻⁹ L/h,
Feedstock gas composition: 2.10⁻⁹ L/h of iC4 and 6.10⁻⁹L/h of nC4.

The membranes according to the first preferred embodiment have, in the n-butane/isobutene separation, an n-butane permeance of at least 3.75·10⁻⁷ mol/m²·s·Pa, preferably at least 4.4·10⁻⁷ mol/m²·s·Pa, and preferably at least 4.25·10⁻⁷ mol/m²·s·Pa, and an i-butane permeance of at most 0.40·10⁻⁷ mol/m²·s·Pa, preferably at most 0.35·10⁻⁷ mol/m²·s·Pa, and preferably at most 0.30·10⁻⁷ mol/m²·s·Pa.

The membranes according to the second preferred embodiment have, in the n-butane/isobutane separation, an n-butane permeance of at least 5.50·10⁻⁷ mol/m²·s·Pa, preferably at least 5.80·10⁻⁷ mol/m²·s·Pa, and preferably at least 6.10·0⁻⁷ mol/m²·s·Pa, and an i-butane permeance of at most 0.50·10⁻⁷ mol/m²·s·Pa, preferably at most 0.45·10⁻⁷ mol/m²·s·Pa and 0.40·10⁻⁷ mol/m²·s·Pa.

In summary, the invention relates to a process for the preparation of a supported zeolite membrane, preferably of MFI structural type, constituted by a zeolite/substrate composite layer, whereby said process comprises:

a) The formation of a gel or a solution that comprises at least one source of silicon and water, with at least one structuring organic compound added, and optionally another framework element that is selected from the group that comprises aluminum, boron, iron, titanium, phosphorus and gallium, and a mineralizing agent;

b) Bringing said gel or said solution that is obtained in stage a) into contact with the porous substrate by total immersion;

c) The crystallization of the zeolite from said gel or said solution in a single stage; and

d) The elimination of the residual agents by calcination,

whereby the crystallization stage c) is conducted while being stirred by a hydrothermal treatment of the immersed substrate, said process also satisfying at least one of the following requirements:

The crystallization is conducted with a water/silicon molar ratio of 66-100,
Before the crystallization stage, the porous substrate is pretreated by covering it at the outer periphery, where the zeolite is not desired, with a polytetrafluoroethylene film and by impregnating it with water in the pores where the zeolite is not desired, and the crystallization is conducted with a water/silica molar ratio of 10-100.

The invention will be described in more detail using examples and comparison examples given below by way of illustration and that are not limiting.

### EXAMPLES

In the examples below, the following products are used:

TPAOH: Tetrapropylammonium hydroxide in solution at 20% (Aldrich)

Pyrogenic silica. Aerosil 380™ with a specific surface area of 380 m²/g, marketed by the DEGUSSA Company

Porous substrate: In hollow tube form of alpha-alumina T1-70 marketed by PALL-EXEKIA, exhibiting the following characteristics;
Length 15 cm
Outside diameter 1 cm
Inside diameter 0.7 cm
Interior surface area of the substrate: 29 cm²
Thickness as follows and mean size of the pores:
   Inner layer: Thickness on the order of 20 μm and mean size of the pores: 0.2 μm;
   Intermediate layer: Thickness on the order of 20 μm and mean size of the pores: 1 μm;
   Outer layer: Thickness on the order of 1.7 mm and size of the pores: 12 μm.

Qualification of the Porous Substrates

In the following examples, the porous substrates are qualified before their use in the following way:

The presence of defects in the crack-type substrate may affect the formation of the zeolite layer and the properties of the zeolite membrane. The absence of defects in the substrate is therefore verified before preparation of the membrane by bulloscopy. This test consists in visualizing the bubbling-through in a solvent of a gas that passes through the substrate and in measuring the flow rate of this gas based on the applied pressure. The substrate is immersed in the ethanol, connected to a nitrogen line at one end, and is plugged at the other. The selected substrate is judged satisfactory when the bubbling-through and the flow of nitrogen appear at a pressure difference of more than 4 bar. The substrate is then dried in an oven at 100° C. for one night so as to evaporate the ethanol. It is called a qualified substrate.

### Example 1

A precursor mixture that is suitable for obtaining the MFI zeolite is prepared. To do this, 27.3 g of TPAOH solution is diluted to 20% in 68.7 g of demineralized water. 4.03 g of pyrogenic silica is slowly dispersed in the dilute TPAOH solution. The mixture is stirred vigorously so as to obtain a clear solution, and the mixture is allowed to age for 3 days at the ambient temperature so as to allow a partial depolymerization and a reorganization of the silica into more reactive silicate radicals than the original silica. The thus obtained mixture has the following molar composition: 1 SiO₂-0.4 TPAOH-75 H₂O.

Bringing the precursor mixture into contact with the qualified substrate is ensured. The mixture is poured into a 100 ml autoclave, and the substrate that is qualified by the bulloscopy test is totally immersed in the reaction medium.

The hydrothermal synthesis is carried out. The autoclave is heated to 175° C. for 60 hours, while being stirred. After this stage, the membrane is recovered, it is washed thoroughly with the demineralized water, then it is dried in an oven at a temperature of 60° C. for one night.

The sealing of the membrane is verified by the qualification test of pure gas at ambient temperature. The permeance of the membrane is measured with nitrogen. The permeance of the nitrogen is zero at an applied gas pressure of 40 kPa, and the membrane is qualified at this stage of the synthesis.

The pores are removed from the zeolite layer by calcination in a tube furnace in air at a temperature of 520° C. for 20 hours at a slow rate of temperature increase (0.5° C./min) and an air flow rate of 1.8 NL/h.

The membrane is characterized by measuring its ideal N₂/SF₆ permselectivity and in a separation of an n-butane/iso-butane mixture.

The results that are obtained are presented in the table below.

### Example 2

A precursor mixture that is suitable for obtaining MFI zeolite is prepared. 31.6 g of TPAOH solution is diluted in advance to 20% in 63.8 g of demineralized water. 4.66 g of pyrogenic silica is slowly poured into this solution while being stirred vigorously so as to obtain a clear solution. This solution is allowed to age for 3 days at ambient temperature so as to ensure depolymerization and reorganization of the silica in more reactive silicate radicals.

The mixture has the following molar composition: 1 SiO₂-0.4 TPAOH-63.7 H₂O.

The substrate that is qualified by the bulloscopy test is first immersed in the demineralized water so as to fill the majority of the pores, then it is recovered. It is then covered on the outer periphery by a Teflon® film. It is thus called a pretreated substrate.

The bringing into contact of the precursor mixture with the qualified and pretreated substrate is ensured. The mixture is poured into a 100 ml autoclave, and the pretreated substrate is totally immersed in the reaction medium.

The hydrothermal synthesis is carried out. The autoclave is heated to 1.75° C. for 60 hours while being stirred. After this stage, the membrane is recovered, it is washed thoroughly with the demineralized water, and then it is dried in an oven at a temperature of 60° C. for one night.

The sealing of the membrane is verified by the qualification test of pure gas at ambient temperature. The permeance of the membrane is measured with nitrogen. The permeance of the nitrogen is zero at an applied gas pressure of 40 kPa, and the membrane is qualified at this stage of the synthesis.

The pores are removed from the zeolite layer by calcination in a tube furnace in air at a temperature of 520° C. for 20 hours, at a slow rate of temperature increase (0.5° C./minute) and an air flow rate of 1.8 NL/h.

The membrane is characterized by measuring its N₂/SF₆ permselectivity and in the separation of an n-butane/iso-butane mixture.

The results are presented in the table below.

### Comparison Example 1

A membrane is prepared according to the synthesis method of Example 1, but by using a precursor mixture exhibiting the following molar composition:

1 Si0₂-0.4 TPAOH-27.6 H₂O, and without any stirring during the crystallization.

### Comparison Example 2

A membrane is prepared according to the synthesis method of Comparison Example 1, but by maintaining the crystallization for 8 hours at 175° C. then by interrupting the temperature for 9 hours and again at 175° C. for 60 hours.

### Comparison Example 3

A membrane is prepared according to the synthesis method of Example 1, but by using a precursor mixture that exhibits the following molar composition:

1 SiO₂-0.4 TPAOH-27.6 H₂O.

### Comparison Example 4

A membrane is prepared according to the synthesis method of Example 1, but by using a precursor mixture that exhibits the following molar composition:

1 SiO₂-0.4 TPAOH-63.7 H₂O.

### Comparison Example 5

A membrane is prepared according to the synthesis method of Example 2, but by using only water as a diffusion barrier.

The membranes prepared in static mode without temperature interruption (Comparison Example 1) were all non-fluidtight before calcination.

25% of the membranes prepared in static mode with temperature interruption were non-fluidtight before calcination (Comparison Example 2).

All of the membranes prepared in stirring mode were fluidtight before calcination.

For each of the membranes that proved to be fluidtight before calcination, the ideal N₂/SF₆ permselectivity was measured, and their performance levels in application were evaluated in the separation of an n-butane/iso-butane mixture.

The results are presented in the table below.

| | | | | Zero N₂ | | |
|---|---|---|---|---|---|---|
| | | | | Permeance | | |
| | Type of | | | Probability | N₂ | SF₆ |
| Examples | Diffusion | | Synthesis | Before | 10 − 7 mol/ | 10 − 7 mol/ |
| (Reference) | Barrier | SiO₂/TPAOH/H₂O | Conditions | Calcination | sm²Pa | sm²Pa |
| Example 1 | None | 1/0.4/75 | 175° C., | 100 | 30.7 | 0.36 |
| (ZAO-85) | | | 60 Hours, | | | |
| | | | Stirring | | | |
| Example 2 | Water + | 1/0.4/63.7 | 175° C., | 100 | 43.6 | 0.45 |
| (ZAO-76) | Teflon | | 60 Hours, | | | |
| | | | Stirring | | | |
| Comparison 1 | None | 1/0.4/27.6 | Static without | 0 | nd | nd |
| (ZAO-39) | | | Temperature | | | |
| | | | Interruption | | | |
| | | | 175° C., | | | |
| | | | 60 Hours | | | |
| Comparison 2 | None | 1/0.4/27.6 | 175° C., | 75 | 2.42 | 0.11 |
| (ZAO-43) | | | 8 + 60 Hours | | | |
| | | | Static with | | | |
| | | | Temperature | | | |
| | | | Interruption | | | |
| Comparison 3 | None | 1/0.4/27.6 | 175° C., | 100 | 3.04 | 0.087 |
| (ZAO-13) | | | 60 Hours, | | | |
| | | | Stirring | | | |
| Comparison 4 | None | 1/0.4/63.7 | 175° C., | 100 | 5.39 | 0.166 |
| (ZAO-11) | | | 60 Hours, | | | |
| | | | Stirring | | | |
| Comparison 5 | Water | 1/0.4/63.7 | 175° C., | 100 | 9.51 | 0.26 |
| (ZAO-87) | Only | | 60 Hours, | | | |
| | | | Stirring | | | |

1. A process for the preparation of a supported zeolite membrane comprising a thin layer of zeolite crystals located for the most part in the pores of a substrate, whereby said process comprises:
a) forming a gel or a solution comprising at least one source of silicon and water, with the addition of at least one structuring organic compound, and optionally another framework element from the group that comprises aluminum, boron, iron, titanium, phosphorus and gallium, and a mineralizing agent;
b) bringing said gel or said solution obtained in stage a) into contact with the porous substrate by total immersion;
c) crystallizing the zeolite crystals from said gel or said solution in a single stage; and
d) eliminating residual agents by calcination,
wherein the crystallization stage c) is conducted in a stirred vessel by a hydrothermal treatment of the immersed substrate, said process also satisfying at least one of the following requirements:
The crystallization is conducted with a water/silicon molar ratio of 66-100,
Before the crystallization stage, the porous substrate is pretreated by covering it at the outer periphery, where the zeolite is not desired, with a polytetrafluoroethylene film or by impregnating it with water in the pores where the zeolite is not desired, and the crystallization is conducted with a water/silica molar ratio of 10-100.

2. A process according to claim 1, wherein the zeolite is of the MFI structural type.

3. A process according to claim 1, wherein the crystallization is conducted with a water/silica molar ratio of 67-90.

4. A process according to claim 1, wherein before the crystallization stage, the porous substrate is pretreated, and the crystallization is conducted with a water/silica molar ratio of 40-90.

5. A process according to claim 1, wherein the structuring organic compound from a group that comprises quaternary ammoniums, amines, alcohols, ethers and organic compounds.

6. A process according to claim 5, wherein
The quaternary ammoniums is from a group that comprises tetrapropyl ammonium (TPA), triethylpropyl ammonium (TEPA), tripropylmethyl ammonium (TPMA), tributylmethyl ammonium, tributylethyl ammonium, tributylhexyl ammonium, tributyloctyl ammonium, trimethylbenzyl ammonium, diethylpropylethyl ammonium, and N,N,N,N′,N′,N′-hexamethyl-1,6-hexanediammonium,
The amines are from a group comprising propylamine, isopropylamine, 3-dimethylamino-2,2′-dimethyl-1-propanol, 1,5-diaminopentane, 1,6-diaminohexane, 1,12-diaminododecane, diethanolamine, dimethanolamine, trimethanolamine, ethanolamine, monoisopropanolamine, monopropanolamine, 3-dimethylamino-2,2-dimethyl-1-propanol, morpholine, and N-ethylpiperidine,
The alcohols are from a group that comprises 1,6-hexanediol, pinacol, 1,12-dimethyl-1,3-propanediol, glycerol, 1,2-propanediol, triethylene glycol, and 1,4-cyclohexanedimethanol,
The ethers are from a group that comprises ethylene glycol dimethyl ether, diethylene glycol dimethyl ether, triethylene glycol dimethyl ether, tetraethylene glycol dimethyl ether, and tetrahydrofuran, diethyl ether,
The organic compounds are from a group that comprises 1-methyl-4-aza-1-azoniabicyclo[2,2,2]octane-4-oxide iodide, oxyethyl lactamide, ethylenediiminetetraacetic acid (EDTA), nitrilotriacetic acid, methylanoxide, tripropylanoxide, tripropylamine-N-oxide, hydroquinone, carboxymethyl cellulose, cellulose hydroxy ethyl ether, sodium n-dodecyl benzene sulfonate, and sodium n-alkyl-polyoxyethylene sulfate.

7. A process according to claim 1, wherein in stage (a), the molar ratio of the structuring organic compound to the silica in said gel or said solution is between 0.2 and 0.8.

8. A process according to claim 1, wherein the porous substrate is from a group that comprises ceramics, aluminas, zirconia, silicas, titanium oxide, carbon, metals, metal alloys, or a mixture of these different materials.

9. A process according to claim 1, wherein the crystallization stage is carried out at a temperature of between 50 and 250° C.

10. A process according to claim 1, wherein the calcination stage is conducted at a temperature of 400-800° C.

11. A membrane that is obtained by the process according to claim 1.

12. A membrane according to claim 11 that exhibits an ideal N₂/SF₆ permselectivity of more than 45.

13. In a membrane process for separation of gases, separation of vapors, or separation of liquids, the improvement wherein the membrane is produced by the process of claim 1.

14. A process according to claim 13 comprising at least one of the following separations:
Separation of linear hydrocarbons (saturated and/or unsaturated) and branched hydrocarbons (saturated and/or unsaturated) that comprise 4 to 8 carbon atoms, more particularly the separation of linear and branched isomers, the separation of linear paraffins and branched paraffins, and the separation of linear olefins and branched olefins;
Separation of aromatic compounds and naphthenes;
Separation of paraffins and olefins;
Separation of linear hydrocarbons and naphthenes, more particularly the separation of paraffins and naphthenes;
Separation of linear hydrocarbons and aromatic hydrocarbons, more particularly the separation of paraffins and aromatic hydrocarbons;
Separation of branched hydrocarbons relative to one another according to their degree of branching, more particularly the separation of mono-branched and di-branched and/or multi-branched hydrocarbons;
Separation of isomers of xylene;
Separation of the following gaseous mixtures: methane/nitrogen, methane/carbon dioxide, methane/carbon monoxide, carbon dioxide/carbon monoxide, and nitrogen/oxygen;
Separation of methane and sulfur-containing compounds, more particularly the separation of methane/hydrogen sulfide or methane/COS;
Separation of hydrogen/hydrocarbons, nitrogen/hydrocarbons, hydrogen/carbon dioxide, and hydrogen/carbon monoxide;
Separation of alcohols and water.
